(19) United States
(12) Patent Application Publication
(10) Pub. No.: US 2012/0194429 A1
(43) Pub. Date: Aug. 2, 2012

(54) IMAGE DISPLAY APPARATUS AND METHOD FOR OPERATING THE SAME

(75) Inventors: Ohkab Kwon, Seoul (KR); Jaekyung Lee, Seoul (KR); Woohwang Park, Seoul (KR); Kunsik Lee, Seoul (KR); Gyuseung Kim, Seoul (KR)

(73) Assignee: LG ELECTRONICS INC., Seoul (KR)

(21) Appl. No.: 13/351,907

(22) Filed: Jan. 17, 2012

Related U.S. Application Data
(60) Provisional application No. 61/437,663, filed on Jan. 30, 2011.

(51) Int. Cl. G09G 5/08

(52) U.S. Cl. 345/157

(57) ABSTRACT

According to an embodiment of the present invention, a method for operating an image display device that receives a signal from a pointing device includes receiving, from the pointing device, a pointing signal to display a pointer on a display of the image display device, and a selection signal, wherein the selection signal includes information regarding a command to perform an operation on the image display device, displaying, on the display, the pointer corresponding to the pointing signal, determining whether the pointer is displayed on a most frequently displayed region during an input standby time associated with the selection signal, and performing an operation associated the most frequently displayed region when the pointer is displayed on the most frequently displayed region during the input standby time.

### CROSS-REFERENCE TO RELATED APPLICATION

This application claims benefit of priority of U.S. Provisional Application No. 61/437,663 filed on Jan. 30, 2011 in the USPTO, the disclosure of which is incorporated herein by reference.

### BACKGROUND OF THE INVENTION

1. Field of the Invention

The present invention relates to an image display device and a method for operating the same, and more particularly to an image display device, which can perform an operation corresponding to user intention using a pointing device, and a method for operating the same.

2. Description of the Related Art

An image display device is an apparatus that can display a broadcast signal, a user input signal, a moving image signal, a signal transmitted from a web server, and the like on a display. Specifically, the image display device displays a broadcast selected by the user from among broadcasts transmitted from broadcasting stations. Currently, broadcasting is transitioning from analog broadcasting to digital broadcasting throughout the world.

Digital broadcasting transmits digital audio and video signals. Digital broadcasting offers many advantages over analog broadcasting. The advantages include robustness against noise, less data loss, and easier error correction. Also, the digital broadcasting provides clearer and high-definition images. In addition, digital broadcasting allows interactive viewer services which analog broadcasting does not provide.

A remote control device such as a remote controller separated from the image display device is used to operate the image display device. There has been a need to add various functions to the remote control device as the image display device have become to perform various operations. Various methods for increasing user convenience have been studied.

### SUMMARY OF THE INVENTION

Therefore, the present invention has been made in view of the above problems, and it is an object of the present invention to provide an image display device, which reduces problems caused by use of a pointing device while a signal is input to perform an operation and allows an operation to be performed as intended by a user, and a method for operating the same.

In accordance with an aspect of the present invention, the above and other objects can be accomplished by the provision of a method for operating an image display device, the method including receiving a pointing signal from a pointing device, displaying a pointer corresponding to the pointing signal, and performing, when a selection signal is received from the pointing device, an operation corresponding to a region in which a pointer corresponding to a pointing signal received during an input standby time has been most frequently displayed during the input standby time.

In accordance with another aspect of the present invention, there is provided an image display device including an interface for receiving a pointing signal and a selection signal from a pointing device, a display for displaying a pointer corresponding to the pointing signal, and a controller for performing, when a selection signal is received from the pointing device, an operation corresponding to a region in which a pointer corresponding to a pointing signal received during an input standby time has been most frequently displayed during the input standby time.

According to an embodiment of the present invention, a method for operating an image display device that receives a signal from a pointing device includes receiving, from the pointing device, a pointing signal to display a pointer on a display of the image display device, and a selection signal, wherein the selection signal includes information regarding a command to perform an operation on the image display device, displaying, on the display, the pointer corresponding to the pointing signal, determining whether the pointer is displayed on a most frequently displayed region during an input standby time associated with the selection signal, and performing an operation associated the most frequently displayed region when the pointer is displayed on the most frequently displayed region during the input standby time.

According to an embodiment of the present invention, a method for operating an image display device includes displaying a pointer within a first object displayed on a display of the image display device, receiving a movement signal from a remote control device to move the pointer, and automatically moving, by the controller, the pointer to inside of a second object adjacent to the first object when the pointer has moved outside the first object according to the movement signal.

According to an embodiment of the present invention, a method for operating an image display device includes displaying a pointer outside a plurality of objects displayed on a display of the image display device, receiving, from a remote control device, a movement signal to move the pointer on the display, the movement signal including information regarding a location of the pointer, moving the pointer on the display according to the movement signal, and automatically moving, by the controller, the pointer onto a particular object among the plurality of objects when the pointer is moved to a predetermined outer area outside of the particular object according to the movement signal.

According to the present invention, it is possible to correctly perform an operation intended by the user when the image display device is controlled using the pointing device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the internal configuration of an image display device according to an embodiment of the present invention;

FIGS. 2A to 2C are perspective views of an image display device and a pointing device that can input a command to the image display device according to an embodiment of the present invention;

FIG. 3 is a block diagram of the pointing device 201 and the interface 150 of the image display device 100 according to an embodiment of the present invention;

FIG. 4 is a flow chart illustrating a method for operating an image display device according to an embodiment of the present invention;

FIG. 5 illustrates a method for operating an image display device according to an embodiment of the present invention together with a screen displayed on a display;

FIG. 6 illustrates change of a pointing signal according to an embodiment of the present invention; and

FIGS. 7 to 9 illustrate a method for operating an image display device according to an embodiment of the present invention.

### DETAILED DESCRIPTION OF THE PREFERRED EMBODIMENTS

Various embodiments of the present invention will be described with reference to the attached drawings.

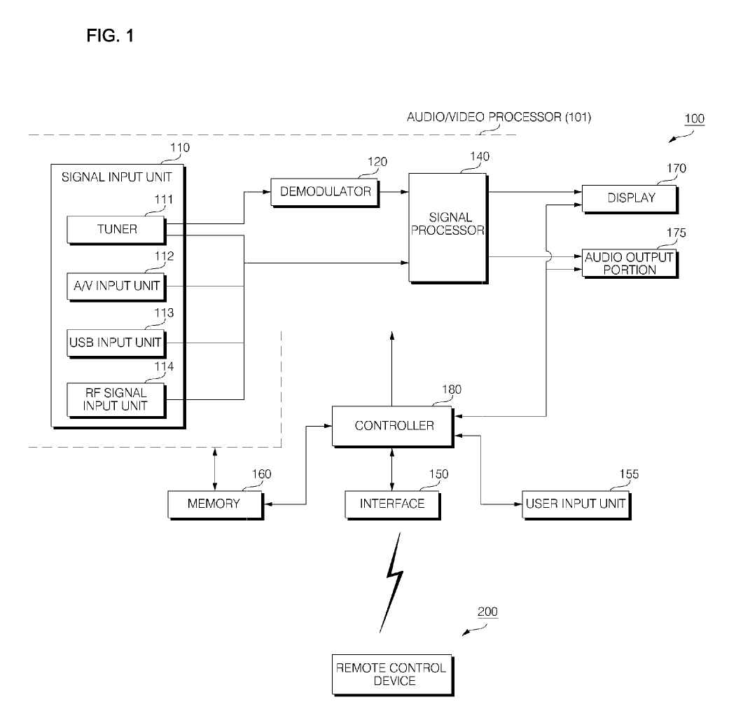

FIG. 1 is a block diagram showing the internal configuration of an image display device according to an embodiment of the present invention.

Referring to FIG. 1, an image display apparatus 100 includes an audio/video (A/V) processor 101, an interface 150, a memory 160, a display 170, an audio output portion 175 and a controller 180.

The A/V processor 101 processes an input audio or video signal so that an image or voice may be output to the display 170 or the audio output portion 175 of the image display device 100. For the video or audio processing, the A/V processor 101 may include a signal input unit 110, a demodulator 120, and a signal processor 140. The signal input unit 110 may include one or more tuners 111, an A/V input unit/module 112, a Universal Serial Bus (USB) input unit/module 113, and a radio frequency (RF) signal input unit/module 114.

The tuners 111 selects a Radio Frequency (RF) broadcast signal corresponding to a channel selected by a user from among a plurality of RF broadcast signals received through an antenna and downconverts the selected RF broadcast signal into an Intermediate Frequency (IF) signal or a baseband audio or video signal. For example, if the selected RF broadcast signal is a digital broadcast signal, the tuner 111 downconverts the RF broadcast signal to a Digital IF (DIF) signal. If the selected RF broadcast signal is an analog broadcast signal, the tuner 111 downconverts the RF broadcast signal to an analog baseband video or audio signal (Composite Video Banking Sync (CVBS)/Sound Intermediate Frequency (SIF)). That is, the tuner 111 is capable of processing a digital or analog broadcast signal. The analog baseband video or audio signal (CVBS/SIF) output from the tuner 111 may be provided directly to the signal processor 140. The tuner 111 may receive a single-carrier RF broadcast signal based on Advanced Television System Committee (ATSC) or a multi-carrier RF broadcast signal based on Digital Video Broadcasting (DVB).

In accordance with another embodiment of the present invention, the image display device 100 may include at least two tuners. If the image display device 100 includes at least two tuners, a second tuner also selects an RF broadcast signal of a user-selected channel from among RF broadcast signals received through the antenna and downconverts the selected RF broadcast signal to an IF signal or a baseband video or audio signal. Also, the second tuner may sequentially select RF signals of all broadcast channels that have been stored by a channel memory function and downconvert the selected RF signals to IF signals or baseband video or audio signals. Here, the second tuner may perform downconversion of the RF signals of all broadcast channels periodically.

Hence, the image display device 100 may provide video signals of a plurality of channels downconverted by the second tuner as thumbnail images, while displaying the video of a broadcast signal downconverted by the first tuner. In this case, the first tuner may downconvert a user-selected main RF broadcast signal to an IF signal or a baseband video or audio signal, and the second tuner may sequentially/periodically select all RF broadcast signals except for the main RF broadcast signal and downconvert the selected RF broadcast signals to IF signals or baseband video or audio signals.

The demodulator 120 demodulates the DIF signal received from the tuner 111. For example, if the DIF signal output from the tuner 111 is an ATSC signal, the demodulator 120 demodulates the DIF signal by 8-Vestigal Side Band (8-VSB). In another example, if the DIF signal output from the tuner 111 is a DVB signal, the demodulator 120 demodulates the DIF signal by Coded Orthogonal Frequency Division Multiple Access (COFDMA) demodulation.

Further, the demodulator 120 may perform a channel decoding. For the channel decoding, the demodulator 120 may include a Trellis decoder, a deinterleaver, and a Reed Solomon decoder, for Trellis decoding, deinterleaving and Reed Solomon decoding, respectively.

After the demodulation and channel decoding, the demodulator 120 may output a Transport Stream (TS) signal. A video signal, an audio signal, or a data signal may be multiplexed in the TS signal. For example, the TS signal may be a Moving Picture Experts Group-2 (MPEG-2) TS that includes a multiplexed MPEG-2 video signal and a Dolby AC-3 audio signal. Specifically, the MPEG-2 TS may include a 4-byte header and 184-byte payload. Thereafter the TS signal output from the demodulator 120 may be provided to the signal processor 140. The signal processor 140 demultiplexes and processes the TS signal and outputs a video signal to the display 170 and an audio signal to the audio output portion 175. An image display device having at least two tuners may have two demodulators. Preferably, a number of demodulators corresponds to a number of tuners, for example. Also, a demodulator may be separately provided for ATSC and DVB.

The signal input unit 110 may connect the image display device 100 to an external device. Here, the external device can be a digital versatile disc (DVD) player, a Blu-ray player, a game player, a camcorder, a computer (laptop computer), etc. The signal input unit 110 sends an external input video signal, an external input audio signal and an external input data signal to the signal processor 140 of the image display device 100. The signal input unit 110 also outputs an audio, video or data signal processed in the image display device 100 to another external device.

In the signal input unit 110, the A/V input module 112 may include a composite video banking sync (CVBS) port, a component port, an S-video port (analog), a Digital Visual Interface (DVI) port, a High Definition Multimedia Interface (HDMI) port, a Red, Green, Blue (RGB) port, a D-SUB port, an Institute of Electrical and Electronics Engineers (IEEE) 1394 port, a Sony/Phillips Digital InterFace (SPDIF) port, a Liquid HD port, etc. in order to provide audio and video signals received from the external device to the image display device 100. Then, analog signals received through the CVBS port and the S-video port may be provided to the signal processor 140 after analog-to-digital conversion and digital signals received through the other input ports may be provided to the signal processor 140 without analog-to-digital conversion.

The USB input module 113 may receive audio and video signals through the USB port.

The RF signal input module 114 may connect the image display device 100 to a wireless network. The image display device 100 may access the wireless Internet or other network through the RF signal input module 114. To connect to the wireless Internet, a communication standard, such as Wireless Local Area Network (WLAN) (Wi-Fi), Wireless Broadband (WiBro), Worldwide Interoperability for Microwave Access (Wimax), High Speed Downlink Packet Access (HSDPA), etc. may be used. Further, the RF signal input module 114 may conduct short-range communications with another electronic device. For example, the RF signal input module 114 may be networked to another electronic device by a communication standard like a Bluetooth, a Radio Frequency Identification (RFID), an InfraRed Data Association (IrDA), an Ultra Wideband (UWB), a ZigBee, etc.

The signal input unit 110 may connect the image display device 100 and a set-top box. For instance, if the set-top box is Internet Protocol (IP) TV capable, the signal input unit 110 may transmit an audio, video or data signal received from the IPTV set-top box to the signal processor 140 and a processed signal received from the signal processor 140 to the IP TV set-top box.

The term ‘IPTV’ as used herein covers a broad range of services, depending on transmission networks, such as Asynchronous Digital Subscriber Line-TV (ADSL-TV), Very high data rate Digital Subscriber Line-TV (VDSL-TV), Fiber To The Home-TV (FTTH-TV), TV over DSL, Video over DSL, TV over IP (TVIP), Broadband TV (BTV), and Internet TV and full-browsing TV which are capable of providing Internet access services.

The signal processor 140 may demultiplex a received TS signal including an MPEG-2 TS into an audio signal, a video signal and a data signal. The signal processor 140 may also process the demultiplexed video signal. For instance, if the demultiplexed video signal was coded, the signal processor 140 may decode the coded video signal. More specifically, if the demultiplexed video signal is an MPEG-2 coded video signal, an MPEG-2 decoder may decode the demultiplexed video signal. If the demultiplexed video signal was coded in compliance with H.264 for Digital Multimedia Broadcasting (DMB) or Digital Video Broadcasting-Handheld (DVB-H), an H.264 decoder may decode the demultiplexed video signal.

Also, the signal processor 140 may control brightness, a tint, and a color for the video signal. The video signal processed by the signal processor 140 is displayed on the display 170 (the signal processor 140 may also process the demultiplexed audio signal).

For example, if the demultiplexed audio signal was coded, the signal processor 140 may decode the audio signal. More specifically, if the demultiplexed audio signal is an MPEG-2 coded audio signal, an MPEG-2 decoder may decode the demultiplexed audio signal. If the demultiplexed audio signal was coded in compliance with MPEG 4 Bit Sliced Arithmetic Coding (BSAC) for terrestrial DMB, an MPEG 4 decoder may decode the demultiplexed audio signal. If the demultiplexed audio signal was coded in compliance with MPEG 2 Advanced Audio Codec (AAC) for satellite DMB or DVB-H, an AAC decoder may decode the demultiplexed audio signal. Further, the signal processor 140 may control a bass, a treble, and a volume of the audio signal. Thereafter, the audio signal processed by the signal processor 140 is provided to the audio output portion 175.

Also, the signal processor 140 may process the demultiplexed data signal. For example, if the demultiplexed data signal was coded, the signal processor 140 may decode the data signal. The coded data signal may be Electronic Program Guide (EPG) information including broadcasting information such as the starts, ends, etc. of broadcast programs of each channel. For instance, the EPG information may be ATSC-Program and System Information Protocol (ATSC-PSIP) information in case of ATSC. In case of DVB, the EPG information may include DVB-Service Information (DVB-SI). The ATSC-PSIP information or DVB-SI may be included in the 4-byte header of the afore-described TS, i.e. MPEG-2 TS.

In addition, the signal processor 140 may perform an On-Screen Display (OSD) function. Specifically, the signal processor 140 may display graphic or text information on the display 170 based on at least one of the processed video and data signals and a user input signal received through a remote control device 200.

Referring to FIG. 1, the memory 160 may store programs for signal processing and control operations of the controller 180, and store processed video, audio or data signals. Also, the memory 160 may temporarily store video, audio or data signals received through the signal input unit 110. The memory 160 may include a storage medium of at least one type of flash memory, hard disk, multimedia card micro type, card-type memory (e.g. Secure Digital (SD) or eXtreme Digital (XD) memory), an optical disk, a removable storage such as a memory stick, Random Access Memory (RAM), and Read Only Memory (ROM) (e.g. Electrically Erasable Programmable ROM (EEPROM)). When a user selects a file to be reproduced, the image display device 100 may reproduce a file stored in the memory 160 (e.g. a moving image file, a still image file, a music file, a text file, etc.) and provide the file to the user.

The controller 180 provides overall control to the image display device 100. The controller 180 may receive a signal from the remote control device 200 via the interface 150. When the user inputs a command input to the remote controller 200, the controller 180 identifies the command input using the received signal and controls the image display device 100 according to the command input. For example, upon receiving a predetermined channel selection command from the user, the controller 180 controls the tuner 111 to provide a selected channel through the signal input unit 110, the signal processor 140 to process the audio and video signals for the selected channel, and the signal processor 140 to output user-selected channel information along with the processed audio and video signals to the display 170 or the audio output portion 175.

Further, the user may enter a different-type video or audio output command through the remote control device 200. For example, if the user wants to view an image from a camera or a camcorder received through the USB input module 113, instead of a broadcast signal, the controller 180 may control the A/V processor 101 and the signal processor 140 to process an audio or video signal received through the USB input module 113 of the signal receiver 110. Then, the controller 180 may output the processed audio and/or video signal to the display 170 and/or the audio output portion 175.

In addition to commands received through the remote control device 200, the controller 180 may also identify a user command received through the user input unit 155 provided to the image display device 100 and control the image display device 100 according to the user command. For example, the user may input other commands such as an on/off command, a channel switch command, a volume change command, or the like to the image display device 100 through the user input unit 155. The user input unit 155 may include buttons or keys formed on the image display device 100 or may be a keyboard a touch screen, a key pad, a stylus, a mouse, etc. The controller 180 determines whether the user input unit 155 has been manipulated and controls the image display device 100 according to the determination result. The image display device 100 can be, e.g., a digital TV, a smart TV, a computer, a notebook, a portable multimedia device, a mobile terminal such as a smart phone, a navigation device, etc.

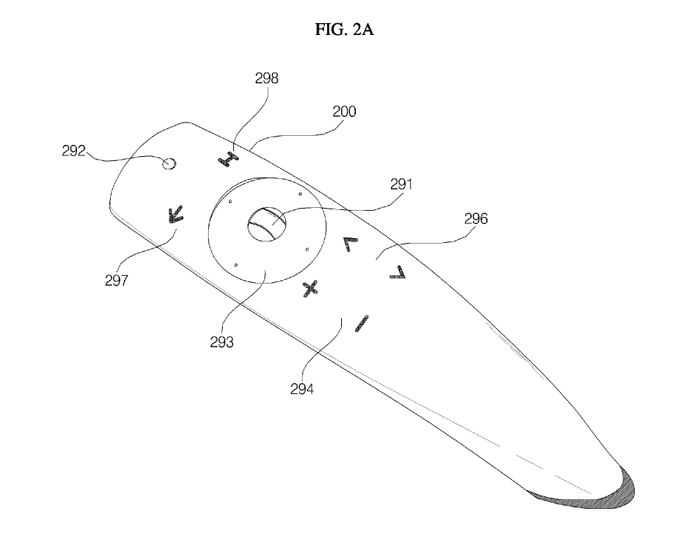

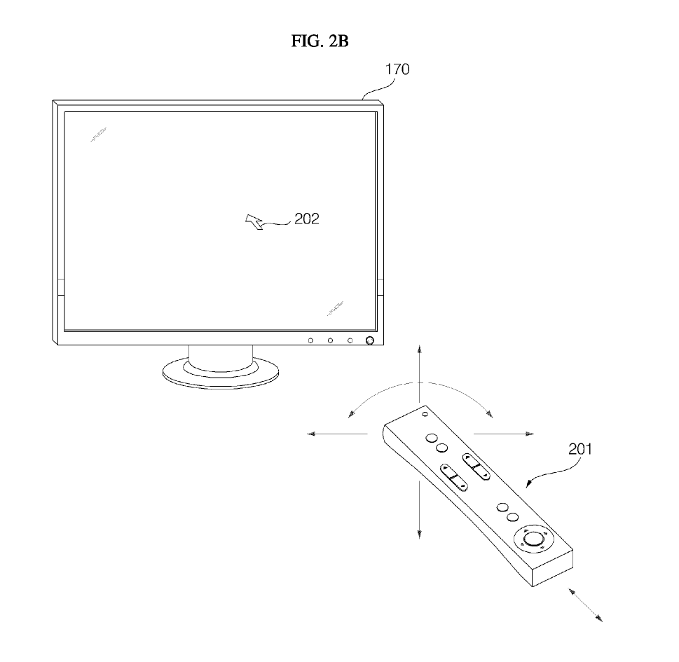

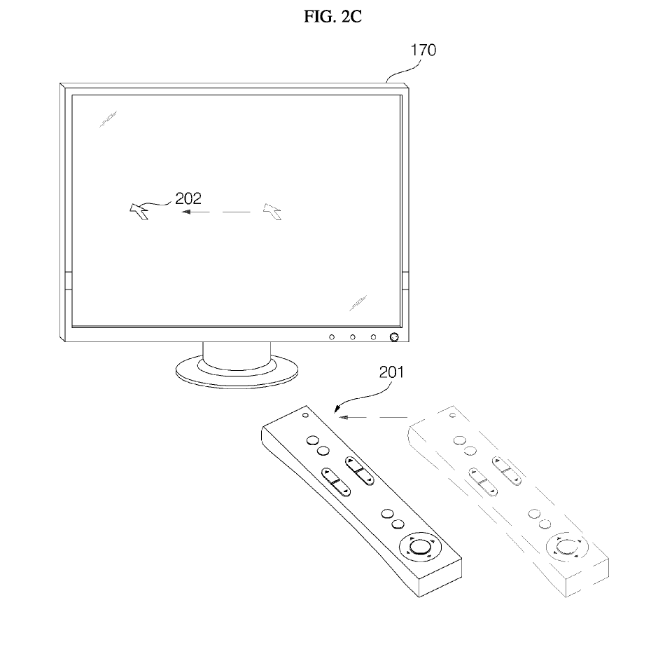

FIGS. 2A to 2C are perspective views of an example of an image display device 100 and a pointing device 201 is able to input a command to the image display device according to an embodiment of the present invention.

The pointing device 201 is an example of the remote control device 200 for entering a command for the image display device 100. In accordance with the embodiment of the present invention, the pointing device 201 transmits and receives signals to and from the image display device 100 in compliance with an RF communication standard.

FIG. 2A shows an example of the pointing device 201 according to an embodiment of the present invention. Referring to FIG. 2A, the pointing device 201 according to the embodiment of the present invention may include various input keys, input buttons, etc. For example, the pointing device 201 may include an okay/enter/select key 291, a menu key 292, a 4-direction key 293, a channel control key 294, and a volume control key 296.

For example, the okay/enter/select key 291 may be used to select a menu or item, the menu key 292 may be used to display a predetermined menu, the 4-direction key 294 may be used to move a pointer or indicator up, down, left and right, the channel control key 294 may be used to move a channel up or down, and the volume control key 296 may be used for volume control. The pointing device 201 may further include a back key 297 and a home key 298. For example, the back key 297 may be used to move a screen to a previous screen and the home key 298 may be used to move a screen to a home screen.

As shown in FIG. 2A, the okay/enter/select key 291 may further include a scroll function. For the scroll function, the okay/enter/select key 291 may be implemented as a wheel key. That is, by pushing the okay/enter/select key 291, a menu or item is selected. When the okay key 291 is scrolled up or down, a display screen is scrolled or a list page is switched in accordance with the scrolled action of the okay/enter/select key 291.

More specifically, for example, when an image having a size greater than the size of the display is displayed on the display 170, the user may scroll the okay/enter/select key 291 to view and to display an image region of the image which is not currently displayed on the display. Further, a list page is displayed on the display 170, the user may scroll the okay/enter/select key 291 to view and display a previous page or a next page of a current page. Such a scroll function may be included separately from the okay key 291.

Referring to FIG. 2A, four-direction key 293 may include up, down, left and right keys in a circular shape. Further, the four-direction key 293 may be configured to receive a touch input. For example, if a touch operation from the up key to the down key in the four-direction key 293 is performed, a predetermined function may be input or performed according to the touch input.

As shown in FIG. 2B, a pointer 202 corresponding to another example of the pointing device 201 may be displayed on a screen of the display 170 of the image display device 100. When the user moves the pointing device 201 up, down, left, right, forward or backward, or rotates it, the pointer 202 may be moved on the image display device 100 in correspondence with the movement of the pointing device 201.

FIG. 2C illustrates a movement of the pointer 202 on the screen of the image display device 100 according to a movement of the pointing device 201. Referring to FIG. 2C, when the user moves the pointing device 201 to the left, the pointer 202 also moves to the left on the image display device 100. In accordance with the embodiment of the present invention, the pointing device 201 includes a sensor for sensing the movement of the pointing device 201. Thus, information about the movement of the pointing device 201 sensed by the sensor is provided to the image display device 100. Then, the image display device 100 determines the movement of the pointing device 201 based on the information about the movement of the pointing device 201 and calculates the coordinates of the pointer 202 corresponding to the movement of the pointing device 201.

Here, the pointer 202 displayed on the display 170 moves in correspondence with an upward, downward, left or right movement or rotation of the pointing device 201. The velocity or direction of the pointer 202 may correspond to that of the pointing device 201. In accordance with the embodiment of the present invention, the pointer is set to move on the image display device 100 in correspondence with the movement of the pointing device 201. It can be further contemplated as another embodiment of the present invention that a particular movement of the pointing device 201 triggers a predetermined command to the image display device 100. For example, if the pointing device 201 moves forward or backward, an image displayed on the image display device 200 may be enlarged or contracted. Therefore, the embodiment of the present invention does not limit the scope of the present invention.

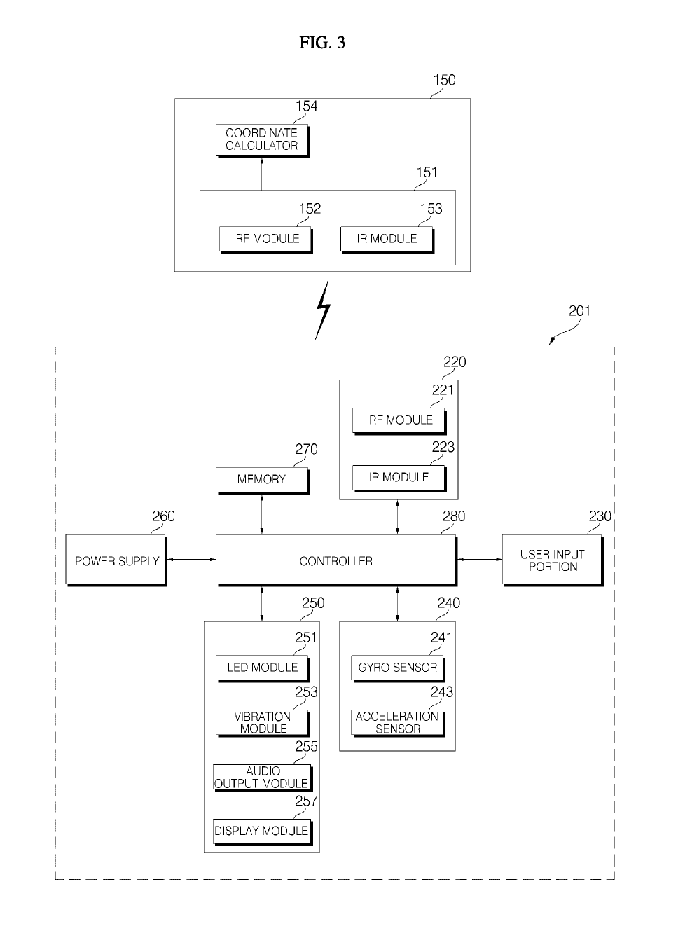

FIG. 3 is a block diagram of an example of the pointing device 201 and the interface 150 of the image display device 100 according to an exemplary embodiment of the present invention. The pointing device 201 is an example of the remote control device 200.

Referring to FIG. 3, the pointing device 201 may include a radio transceiver 220, a user input portion 230, a sensor portion 240, an output portion 250, a power supply 260, a memory 270, and a controller 280, all operably coupled.

The radio transceiver 220 transmits and receives signals to and from the image display device 100. In accordance with the embodiment of the present invention, the pointing device 201 may be provided with an RF module 221 for transmitting and receiving signals to and from the interface 150 of the image display device 100 according to an RF communication standard. Also, the pointing device 201 may include an IR module 223 for transmitting and receiving signals to and from the interface 150 of the image display device 100 according to an IR communication standard.

In accordance with the embodiment of the present invention, the pointing device 201 transmits signal carrying information about an operation of the pointing device 201 to the image display device 100 through the RF module 221. Also, the pointing device 201 may receive a signal from the image display device 100 through the RF module 221. Thus, the pointing device 201 may transmit commands associated with a power on/off, a channel switching, a volume change, etc. to the image display device 100 through the IF module 223.

Also, the user input portion 230 may include a keypad or buttons. The user may enter a command to the pointing device 201 by manipulating the user input portion 230 to an operation to be performed on the image display device 100. For example, if the user input portion 230 includes hard keys, the user may push the hard keys of the pointing device 201 for commands to be performed on the image display device 100. Furthermore, if the user input portion 230 is provided with a touch screen, the user may touch soft keys on the touch screen of the pointing device 201 for commands to be performed on the image display device 100. Also, the user input portion 230 may have a variety of input means which may be manipulated by the user, such as a scroll key, a jog key, etc., to which the present invention is not limited.

The sensor portion 240 may include at least one of a gyro sensor 241 and an acceleration sensor 243. The gyro sensor 241 may sense an operation of the pointing device 201. For example, the gyro sensor 241 may detect the directional information about an operation of the pointing device 201 along x, y and z axes. The acceleration sensor 243 may detect velocity information of the pointing device 201.

In accordance with the embodiment of the present invention, in the sensor portion 240, the gyro sensor 241 and the acceleration sensor 243 may be replaced with other sensors or other sensors may be included in addition to the gyro sensor 241 and the acceleration sensor 243, in order to detect positional and moving data and information associated with the pointing device 201. For example, the sensor portion 240 may include a geomagnetic sensor. In the geomagnetic sensor, three sensors for measuring strength of a magnetic field are provided along X, Y and Z axes, and the direction of the magnetic field influencing the sensors may be measured by a sum of output vectors of the three sensors. Therefore, the movement of the pointing device 201 can be sensed based on a change in a magnetic field.

Referring to FIG. 3, the output portion 250 may output a video or audio signal corresponding to a manipulation of the user input portion 230 or a signal transmitted by the image display device 100. The user may be aware from the output portion 250 whether the user input portion 230 has been manipulated or the image display device 100 has been controlled. For example, the output portion 250 may include a Light Emitting Diode (LED) module 251. The output portion 250 is illuminated when the user input portion 230 has been manipulated or a signal is transmitted to or received from the image display device 100 through the radio transceiver 220, a vibration module 253 for generating vibrations, an audio output module 255 for outputting audio, and/or a display module 257 for outputting video.

The power supply 260 supplies the power to the pointing device 201. When the pointing device 201 is kept stationary for a predetermined time, the power supply 260 blocks the power from the pointing device 201. When a predetermined key of the pointing device 201 is manipulated, the power supply 260 may resume a power supply.

The memory 270 may store a plurality of types of programs required for controlling or operating the pointing device 201, or application data. When the pointing device 201 transmits and receives signals to and from the image display device 100 wirelessly through the RF module 221, the pointing device 201 and the image display device 100 perform signal transmission and a signal reception in a predetermined frequency band. The controller 280 of the pointing device 201 may store information about the frequency band to wirelessly transmit and receive signals to and from the image display device 100 paired with the pointing device 201 in the memory 270, and the controller 280 may refer to the information.

The controller 280 provides an overall control to the pointing device 201. The controller 280 may transmit a signal corresponding to a predetermined key manipulation on the user input portion 230 or a signal corresponding to an operation of the pointing device 201 detected by the sensor portion 240 to the interface 150 of the image display device 100 through the radio transceiver 220.

Here the interface 150 of the image display device 100 may include a radio transceiver 151 for wirelessly transmitting and receiving signals to and from the pointing device 201, and a coordinate calculator 154 for calculating the coordinates of the pointer corresponding to an operation of the pointing device 201. Further, the interface 150 may transmit and receive signals wirelessly to and from the pointing device 201 through the RF module 152. The interface 150 may also receive a signal from the pointing device 201 through the IR module 153 based on the IR communication standard.

The coordinate calculator 154 may calculate the coordinates (x, y) of the pointer 202 to be displayed on the display 170 by correcting a handshaking or errors from a signal corresponding to an operation of the pointing device 201 received through the radio transceiver 151.

Thereafter, a signal received from the pointing device 201 through the interface 150 is provided to the controller 180 of the image display device 100. The controller 180 may identify information about an operation of the pointing device 201 or a key manipulation on the pointing device 201 from the signal received from the pointing device 201 and control the image display device 100 according to the identical information.

In another example, the pointing device 201 may calculate the coordinates of the pointer corresponding to the operation of the pointing device and output the coordinates to the interface 150 of the image display device 100. The interface 150 of the image display device 100 may then transmit the received coordinate information to the controller 180 without correcting a handshaking or errors.

FIGS. 1, 2A-2C and 3 illustrate the image display device 100 and the pointing device 201 as the remote control device 200 according to an embodiment of the present invention. The components of the image display device 100 and the pointing device 201 may be integrated or omitted, or a new component may be added. That is, when needed, two or more components may be incorporated into a single component or one component may be configured to be divided into two or more separate components. Also, the function of each block is presented for illustrative purposes, not limiting the scope of the present invention.

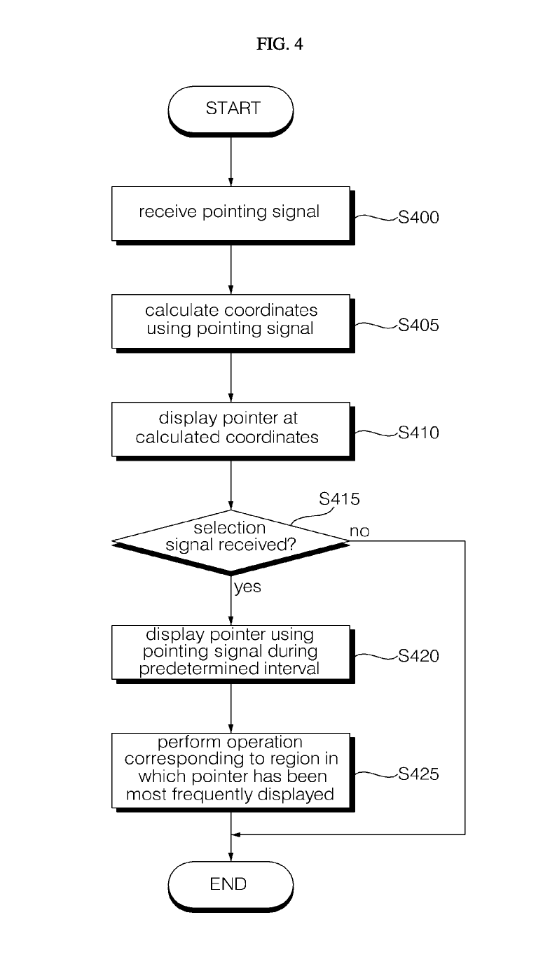

FIG. 4 is a flow chart illustrating a method for operating an image display device according to an embodiment of the present invention. The method of FIG. 4 can be implemented by the device of FIGS. 1-3 or by other suitable devices.

As shown in FIG. 4, at least one of objects including a broadcast image and a menu icon is displayed on the display 170 and a wireless communication unit (e.g., radio transceiver 151) receives a pointing signal from the pointing device 201 (S400). The pointing signal includes values output from the gyro sensor 241 and/or the acceleration sensor 243 included in the pointing device 201. When the pointing device 201 is in an active state, a pointing signal is continuously transmitted from the pointing device 201 to the wireless communication unit.

Then, the controller 180 calculates x and y coordinates on the display 170 using the pointing signal received in step S400 (S405). The controller 180 displays a pointer on the display 170 according to the calculated coordinates (x, y) (S410). The pointer 202 may be displayed not only as an arrow but also as a cursor or finger image and may be displayed so as to opaquely overlap the menu icon or broadcast image on the display 170.

The controller 180 then determines whether or not a selection signal has been transmitted from the pointing device 201 (S415). The selection signal is a signal that is transmitted from the pointing device 201 to the wireless communication unit when a user command is input through the user input portion 230. The selection signal includes information regarding a command to execute one or more of various operations on the image display device 100. While the selection signal is transmitted, a pointing signal is continuously transmitted from the pointing device 201.

When the selection signal is transmitted from the pointing device 201, the user input unit 155 calculates coordinates of the pointer using a pointing signal that has been input for a predetermined interval prior to a time point at which the selection signal is transmitted and the controller 180 displays the pointer 202 on the display 170 based on the pointing signal input within the predetermined interval (S420). For example, if the predetermined time interval is 400 ms and the selection signal was received at a time T, then the controller 180 calculates coordinates where the pointer was located during T−400 ms and T. Thereafter, the controller 180 determines whether the selected operation is what the user intended to select by comparing the calculated coordinates of the pointer within the predetermined time interval. The predetermined interval may include an interval in which a pointing signal corresponding to the same coordinates is input for a predetermined time or longer. The predetermined interval will hereinafter be referred to as an “input standby time” for the selection signal. The input standby time may be 400 ms (i.e., 0.4 s) prior to the time point at which the selection signal is transmitted.

On the other hand, the coordinate calculator 154 may store information regarding a pointing signal input during the input standby time. That is, since it is difficult to predict when the selection signal will be transmitted again, the coordinate calculator 154 stores information of a position signal input simultaneously with the input standby time. Thus, when another selection signal is transmitted later, the coordinate calculator 154 can immediately calculate coordinates using the information regarding the pointing signal stored in real time.

Thereafter, the controller 180 performs an operation based on the calculated coordinates of the pointer to determine a region where the pointer was displayed for the most time during the input standby time (S425). That is, the controller 180 calculates coordinates for a pointing signal input during the input standby time where the pointer was displayed, thereby determining that the selectable region where the selection signal was received is the region that the user in fact selected to perform an operation corresponding to the selection signal. Thus, once the selection signal is received, the controller 180 calculates the coordinates of the pointer during the input standby time and determines that the coordinates of the pointer were at the particular selectable region for most of the time during the input standby time. Then, the controller 180 executes an operation associated with the particular selectable region where the pointer was displayed for the most of the time during the input standby time. This particular selectable region will also be referred herein as the “most frequently displayed region.”

For example, when a selection signal is input from the pointing device, the controller 180 may execute a menu object displayed at a position corresponding to the most frequently displayed region.

The method according to an embodiment of the present invention may further include selecting an object displayed in a region in which the pointer has been most frequently displayed. Here, a display state of the selected object such as color and size may be different from another object.

Here, a region in which the pointer is displayed may be an inside region of an object. In this case, the controller 180 may perform an operation corresponding to the object.

It is possible that although the user intended to execute one operation, due to an unwanted hand shaking of the user, the user may select a selectable object associated with another operation. By calculating the most frequently displayed region, the image display device may correctly select the operation that the user actually intended to execute. Therefore, it is possible to correct an unwanted selection of an operation due to a hand shaking by performing an operation corresponding to coordinates of the most frequently displayed region calculated during the predetermined interval. Accordingly, the controller 180 may perform a menu item displayed at a position corresponding to coordinates of the most frequently displayed region calculated on the display 170 and may display an image at a position corresponding to the calculated coordinates of the most frequently displayed region.

For example, when a selection signal has been input, a menu icon displayed on the display 170 at a position corresponding to the calculated coordinates of the most frequently displayed region in step S420 may be selected and a submenu of the selected menu icon may be displayed or a menu item corresponding to the selected menu icon may be executed.

The image displayed at the position corresponding to the most frequently displayed region may include any image that is distinguished from images displayed on the display 170 before the selection signal is input and may be expressed as a dot, a line, or a surface. For example, in the case where selection signals are continuously input, dot images may be continuously displayed on the display 170 and a character (or a letter) may be displayed using the continuously displayed dots on the display 170 of the image display device 100.

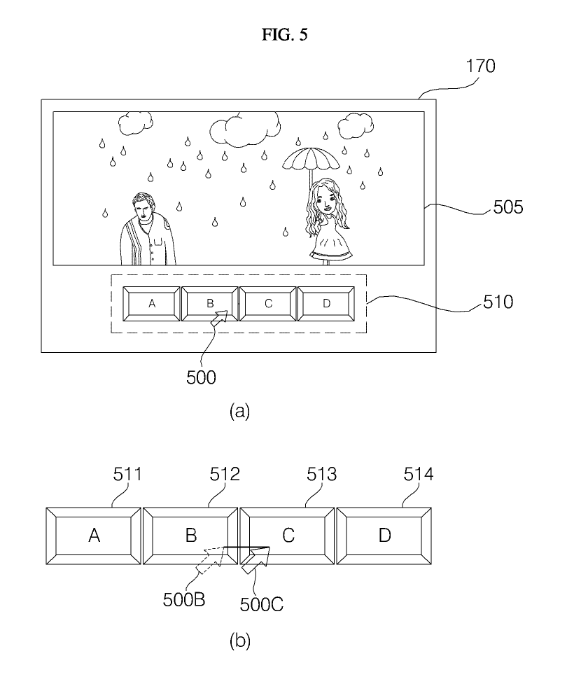

FIG. 5 illustrates a method for operating an image display device according to an embodiment of the present invention together with a screen displayed on a display 170.

As shown in FIG. 5(a), a broadcast image 505 and an object 510 including A, B, C, and D icons are displayed on a display region on the display 170. A pointer 500 is displayed in the display region according to coordinates calculated from a pointing signal. Since the pointer 500 is displayed so as to opaquely overlap the object 510 to allow the user to correctly identify the position of the pointer 500. In order to execute a menu item corresponding to the B icon, for example, the user controls the pointing device 201 such that the pointer 500 is displayed in a region in which the B icon is displayed and generates a selection signal using the user input portion 230 of the pointing device 201.

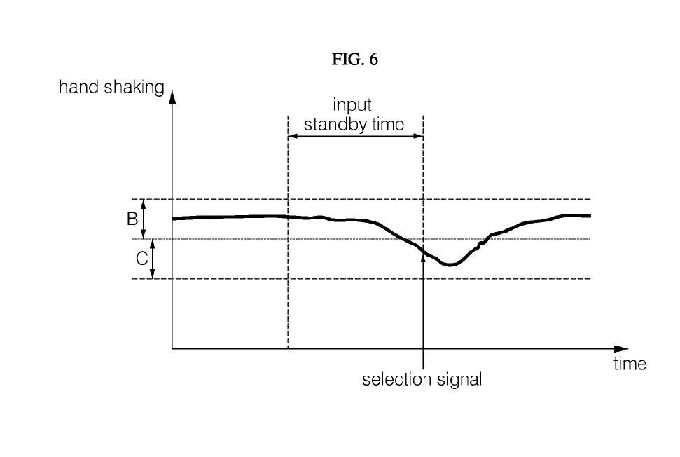

When the object 510 and the pointer 500 are enlarged and displayed on the display 170, an A icon 511, a B icon 512, a C icon 513, and a D icon 514 are displayed adjacent to each other with boundaries therebetween as shown in FIG. 5(b). The user pushes the user input portion 230 of the pointing device 201 after controlling the pointing device 201 such that the pointer 500 is displayed in a region in which the B icon is displayed. In this case, due to a momentary hand shaking of the user, the pointing device may be controlled to change the pointing signal to the C icon 513. Thus, the user input portion 230 of the pointing device 201 may transmit a selection signal selecting the C icon 513 at a location of a pointer 500C due to hand shaking of the user even when the user actually intended to select the B icon 512. That is, a menu item corresponding to the C icon rather than a menu item corresponding to the B icon may be executed due to the user's hand shaking. However, in this case, if the controller 180 determines that the most frequently displayed region during the input standby time is on a location of the B icon 512, the controller 180 may execute the B icon 512 instead of the C icon 513. This will be explained in connection with FIG. 6.

FIG. 6 illustrates change of a pointing signal according to an embodiment of the present invention.

As shown in FIG. 6, the vertical axis represents the degree of the hand shaking for a user holding the remote control device 200 and the horizontal axis represents time. With reference to FIGS. 5 and 6, while a pointing signal corresponding to coordinates at which the B icon is displayed is continuously input, the pointing signal may be changed due to a temporary hand shaking as a selection signal is transmitted. Then, a pointing signal corresponding to coordinates at which the C icon is displayed is input. Therefore, to correct this error, the controller 180 calculates the most frequently displayed region during the input standby time. If the controller 180 determines that the most frequently displayed region is the location of the B icon 512, for example, although the selected region is a location of the C icon 513, an operation associated with the B icon 512 may be executed. The input standby time may be a duration of 0.4 seconds prior to the time point at which a selection signal is input. That is, it is possible to differentiate a user selection based on a temporary handshaking from an actual intended selection by the user.

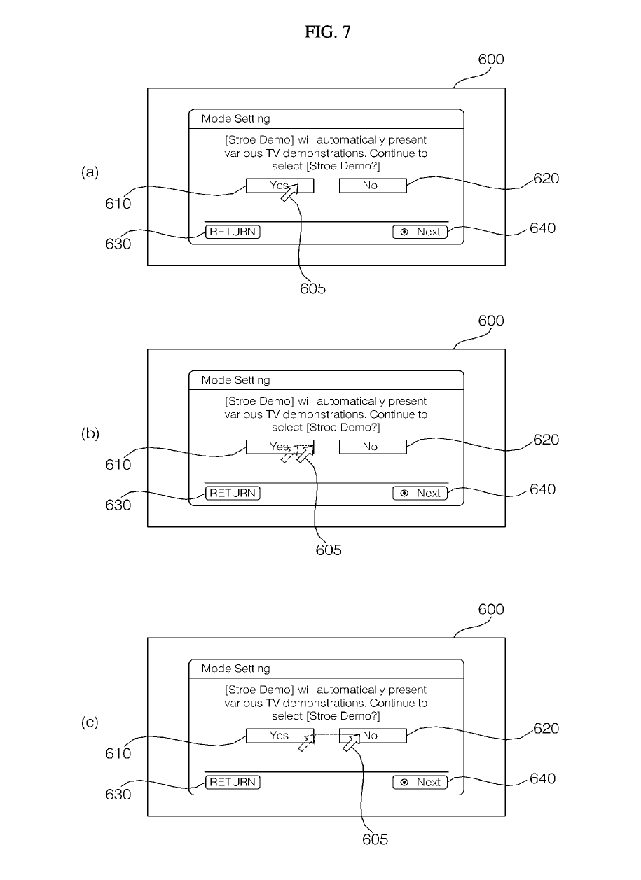

FIG. 7 illustrates a method for operating an image display device according to an embodiment of the present invention.

A display 600 is illustrated. The display 600 may be an example of the display 170 of the image display device 100. Referring to FIG. 7, a pointer 605 is displayed in a first object on the display 600. For example, as shown in FIG. 7(a), a plurality of objects 610, 620, 630, and 640 may be displayed on the display 600 and a pointer 605 may be displayed in the first object 610.

The pointer 605 is an indicator that is displayed on the display 600 according to a pointing signal received from the remote control device 200. Although an arrow is displayed as an example of the pointer 605 in FIG. 7, the pointer may be displayed as a cursor or finger image without being limited to the arrow. The pointer 605 may be displayed on the display 600 so as to opaquely overlap the objects 610, 620, 630, and 640 displayed on the display 600.

Although various embodiments of the remote control device 200 are possible, the following description will be given with reference to the case where the remote control device 200 is a pointing device 201 as described above.

The controller 180 then determines whether or not a movement signal has been input. The movement signal may include information regarding pointer coordinates calculated through the interface 150 or the like as described above. By receiving the coordinate information in real time, the controller 180 can determine whether or not a movement signal has been input from the pointing device 201.

Upon receiving the movement signal from the pointing device 201, the controller 180 displays the pointer 605 on the display 600 such that the pointer 605 moves according to the movement signal. That is, the controller 180 controls the pointer 605 to be displayed such that the pointer 605 moves on the display 600 according to the movement signal.

For example, as shown in FIG. 7(b), the controller 180 displays the pointer 605 moving to the right side on the display 600 when a right movement signal is input from the pointing device 201 while the moving pointer 605 is displayed within the first object 610 on the display 600.

The controller 180 then determines whether or not the pointer 605 is moved to the outside the object 610. Then, the controller 180 compares boundary coordinates of the first object 610 with coordinates to which the pointer 605 has moved and determines whether or not the moved coordinates of the pointer 605 have exited the boundary coordinates of the first object 610.

When the pointer 605 is displayed outside the first object 610, the controller 180 automatically moves the pointer 605 to the inside of the second object 620 adjacent to the first object 610. That is, once the pointer 605 have exited the first object 610, the controller 180 automatically moves the pointer 605 to the inside of the second object 620 adjacent to the first object 610 rather than displaying the pointer 605 at the moved coordinates.

For example, as shown in FIG. 7(c), as soon as the pointer 605 moves out of the first object 610 on the display 600, the pointer 605 is automatically and instantaneously moved to the inside of the second object 620 immediately adjacent to the first object 610. Here, the second object 620 may be located next to the first object in the direction to which the pointer 605 is moving. Although the pointer 605 is automatically moved and displayed inside of the second object 620 adjacent to the first object 610 at the right side thereof according to the right movement signal in the illustrated example, the present invention is not limited to this example and various other embodiments are possible. For example, the pointer 605 may be automatically moved to the inside of another object that is located closest to the first object 610 or an object that is located closest to the first object 610 in the direction the pointer 605 is moving. According to this scheme, the second object 620 is also selected in the illustrated example.

Examples of the object may include a menu and a widget as described above. For example, the object may be a selectable menu item. The controller 180 may identify the object by analyzing an image signal displayed on the display 600.

The automatic moving of the pointer in the above manner allows the user to easily move the pointer to the inside of an adjacent object. This provides an increased convenience for the user and there is no need to perform a high-precision hand shaking correction.

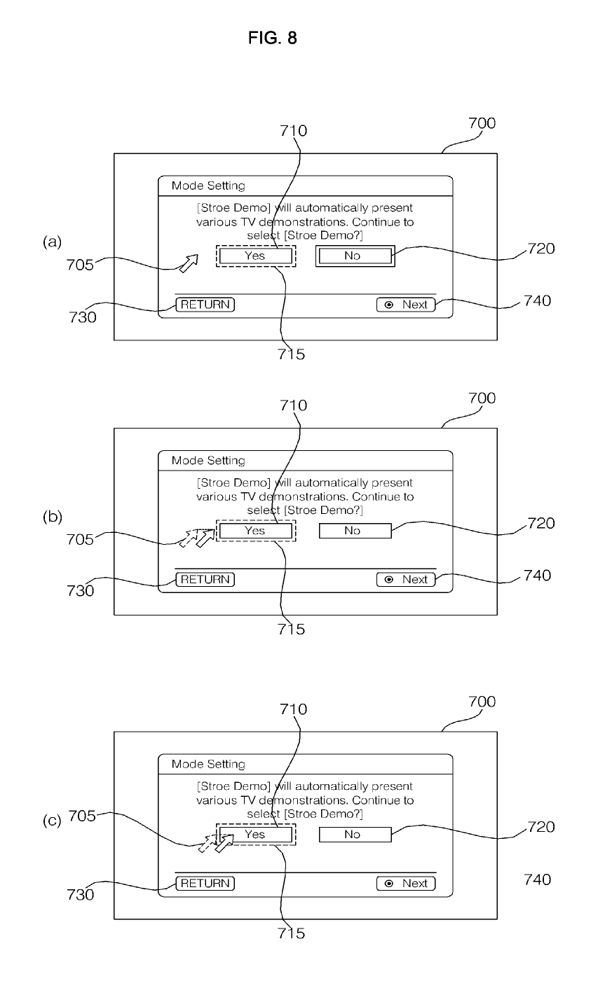

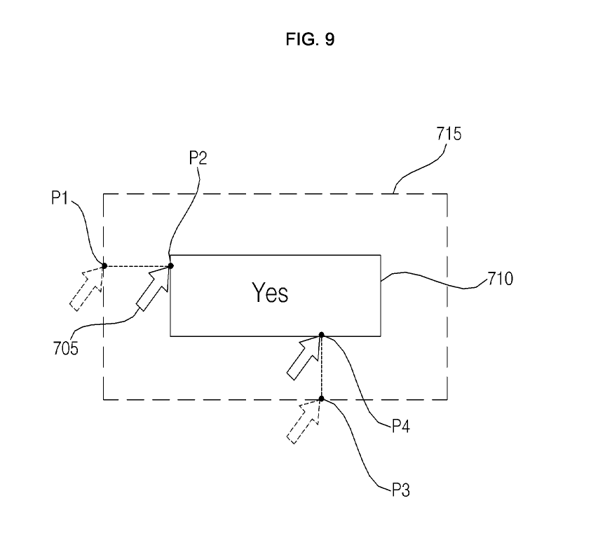

FIGS. 8 and 9 illustrate a method for operating an image display device according to an embodiment of the present invention.

As shown in FIGS. 8 and 9, first, a pointer 705 is displayed outside a plurality of objects on a display 700. The display 700 may be an example of the display 170. For example, as shown in FIG. 8(a), the pointer 705 may be displayed outside a plurality of objects 710, 720, 730, and 740 on the display 700. In an example of FIG. 8(a), the pointer 705 is displayed at the left side of the first object 710.

The pointer 705 is an indicator that is displayed on the display 700 according to a pointing signal received from the remote control device 200. Although an arrow is displayed as an example of the pointer 705 in FIG. 8, the pointer may be displayed as a cursor or finger image without being limited to the arrow. The pointer 705 may be displayed on the display 700 so as to opaquely overlap the objects 710, 720, 730, and 740 displayed on the display 700.

Although various embodiments of the remote control device 200 are possible, the following description will be given with reference to the case where the remote control device 200 is a pointing device 201 as described above.

The controller 180 then determines whether or not a movement signal has been received from the pointing device 201. The movement signal may include information regarding pointer coordinates calculated through the interface 150 or the like as described above. By receiving coordinate information in real time, the controller 180 can determine whether or not a movement signal has been input from the pointing device 201.

Upon receiving a movement signal from the pointing device 201, the controller 180 moves the pointer 705 on the display 700 according to the movement signal. That is, the controller 180 controls the pointer 705 to be displayed such that the pointer 705 moves according to the movement signal. For example, as shown in FIG. 8(b), the controller 180 displays the pointer 705 such that the pointer 705 moves to the right side on the display 700 when a right movement signal is input from the pointing device 201 with the pointer 705 being displayed at the left side of the first object 710 on the display 700.

The controller 180 then determines whether or not the pointer 705 has approached the first object 710 within a predetermined range. The controller 180 compares boundary coordinates of the first object 710 with coordinates to which the pointer 705 has moved and determines whether or not the moved coordinates of the pointer 705 have reached the predetermined range 715 of the boundary coordinates of the first object 710. The predetermined range 715 may be a predetermined boundary region around the first object 710. Although the boundary region has uniform vertical and horizontal widths around the first object 710 in the example of FIG. 8, the boundary region may be set variously without being limited to the example.

When the pointer 705 has approached the first object 710 within the predetermined range 715, the controller 180 automatically moves and displays the pointer 705 inside of the first object 710. For instance, when the moved coordinates of the pointer 705 have reached or entered the boundary coordinates the predetermined range 715 of the first object 710, the controller 180 displays the pointer 705 such that the pointer 705 automatically moves to the inside of the first object 710 rather than displaying the pointer 705 at the moved coordinates. For example, as shown in FIG. 8(c), as soon as the pointer 705 enters the predetermined range 715 of the first object 710 on the display 700, the pointer 705 is automatically and instantaneously moved to the inside of the first object 710.

Although the pointer 705 is displayed such that the pointer 705 automatically moves to a right direction according to a right move command in the FIG. 8(c), the present invention is not limited to the specific embodiment.

For example, as shown in FIG. 9, the pointer 705 displayed under a portion of the first object 710 moves to an up direction according to an up move command, as soon as the pointer 705 enters the predetermined range 715 of the first object 710 on the display 700, the pointer 705 is displayed such that the pointer 705 automatically moves to the inside of the first object 710. For example, when the pointer 705 is moved to P1, the pointer 705 is automatically moved to P2. On the other hand, when the pointer 705 approaches P3, the pointer 705 is automatically moved to P4.

Although a plurality of objects is displayed such that predetermined ranges of the objects do not overlap each other in the illustrated example, the predetermined ranges of the objects may overlap each other. In this case, it is preferable that the pointer 705 automatically move to the first accessible one (for example, a closest one) of the objects.

In the case where a plurality of objects is displayed at the same distances from each other while predetermined ranges of the objects overlap each other, it is preferable that the pointer 705 be displayed such that the pointer 705 moves to the inside of an object having the largest area among the objects since the user may be likely to select the object having the largest area.

Examples of the object may include a menu and a widget as described above. For example, the object may be a selectable menu item. The controller 180 may identify the object by analyzing an image signal displayed on the display 700.

An automatic moving of the pointer in the above manner of the invention allows the user to easily move the pointer to the inside of an adjacent object. This has advantages in that user convenience is increased and there is no need to perform high-precision hand shaking correction.

As is apparent from the above description, according to the present invention, it is possible to correctly perform an operation intended by the user when the image display device is controlled using the pointing device.

The embodiments of the present invention can be embodied as a processor readable code stored in a processor readable medium provided in an image display device. The processor readable medium includes any type of storage device that stores data which can be read by a processor. Examples of the processor readable medium include a Read Only Memory (ROM), a Random Access Memory (RAM), CD-ROMs, magnetic tapes, floppy disks, optical data storage devices, and so on. The processor readable medium can also be embodied in the form of carrier waves such as signals transmitted over the Internet. The processor readable medium can also be distributed over a network of coupled processor systems so that the processor readable code is stored and executed in a distributed fashion.

Although the embodiments of the present invention have been illustrated and described above with reference to the specific embodiments, the present invention is not limited to the specific embodiments and it will be apparent to those skilled in the art that various modifications can be made to the embodiments without departing from the scope of the present invention as disclosed in the accompanying claims and such modifications should not be construed as departing from the spirit or scope of the present invention.

What is claimed is:

1. A method for operating an image display device that receives a signal from a pointing device, the method comprising:
receiving, from the pointing device, a pointing signal to display a pointer on a display of the image display device, and a selection signal, wherein the selection signal includes information regarding a command to perform an operation on the image display device;
displaying, on the display, the pointer corresponding to the pointing signal;
determining whether the pointer is displayed on a most frequently displayed region during an input standby time associated with the selection signal; and
performing an operation associated the most frequently displayed region when the pointer is displayed on the most frequently displayed region during the input standby time.

2. The method according to claim 1, further comprising:
selecting an object displayed in the most frequently displayed region of the display in response to the selection signal.

3. The method according to claim 2, wherein a display state of the selected object is different from another object.

4. The method according to claim 1, further comprising:
storing information of the pointing signal received during the input standby time.

5. The method according to claim 1, wherein the pointer is displayed so as to opaquely overlap a menu icon.

6. The method according to claim 1, wherein performing the operation associated the most frequently displayed region includes:
determining the input standby time associated with the selection signal;
determining whether a particular region was selected in response to the selection signal;
determining whether the most frequently displayed region corresponds to the determined particular region during the determined input standby time; and
performing the operation associated with the most frequently displayed region when the particular region is not the most frequently displayed region.

7. The method according to claim 6, wherein the input standby time corresponds to a predetermined time interval measured from a first time point to a second time point, and the first time point is when the selection signal is received and the second time point is a predetermined time period prior to the first time point.

8. The method according to claim 1, wherein the most frequently displayed region corresponds to a region where the pointer was displayed for the most of a time during the input standby time.

9. A method for operating an image display device including a controller, the method comprising:
displaying a pointer within a first object displayed on a display of the image display device;
receiving a movement signal from a remote control device to move the pointer; and
automatically moving, by the controller, the pointer to inside of a second object adjacent to the first object when the pointer has moved outside the first object according to the movement signal.

10. The method according to claim 9, wherein the first and second objects are selectable objects.

11. The method according to claim 9, wherein the second object is arranged at a location to which the pointer corresponding to the movement signal is moving.

12. The method according to claim 9, wherein the second object is closest to the first object.

13. The method according to claim 9, wherein the remote control device is a pointing device.

14. A method for operating an image display device including a controller, the method comprising:
displaying a pointer outside a plurality of objects displayed on a display of the image display device;
receiving, from a remote control device, a movement signal to move the pointer on the display, the movement signal including information regarding a location of the pointer;
moving the pointer on the display according to the movement signal; and
automatically moving, by the controller, the pointer onto a particular object among the plurality of objects when the pointer is moved to a predetermined outer area outside of the particular object according to the movement signal.

15. The method according to claim 14, wherein the particular object is a selectable object.

16. The method according to claim 14, further comprising:
automatically moving the pointer to one of a first and a second objects based on a predetermined condition when the pointer has approached a location on the display, a first predetermined outer area of the first object and a second predetermined outer area of the second object overlapping each other and distances from the location to the first and second predetermined area being substantially the same.

17. The method according to claim 16, wherein the predetermined condition includes a size, a frequent usage, or a recent usage of the object.

18. The method according to claim 14, wherein the remote control device is a pointing device.

19. The method according to claim 14, further comprising:
automatically moving the pointer to one of the plurality of objects closest to a location of the pointer on the display when predetermined outer areas of the plurality of objects overlap each other at the location, wherein shapes and sizes of the predetermined outer areas are different.

20. The method according to claim 14, wherein the automatically moving the pointer onto the particular object further comprises:
determining whether the pointer approached a predetermined boundary region around the particular object; and
automatically moving the pointer inside the particular object when the pointer approached a predetermined boundary region.
